(19) United States
(12) Patent Application Publication
(10) Pub. No.: US 2013/0003490 A1
(43) Pub. Date: Jan. 3, 2013

(54) KITCHEN APPLIANCE

(75) Inventors: Uwe Kemker, Wuppertal (DE); Torsten Lang, Solingen (DE); Jutta Schomacher, Wuelfrath (DE)

(73) Assignee: VORWERK & CO. INTERHOLDING GMBH, Wuppertal (DE)

(21) Appl. No.: 13/521,263

(22) PCT Filed: Nov. 19, 2010
(86) PCT No.: PCT/EP10/67802

§ 371 Date: Aug. 28, 2012

(30) Foreign Application Priority Data
Nov. 25, 2009 (DE) 10 2009 055 794.6
Nov. 18, 2010 (DE) 10 2010 060 650.2

(51) Int. Cl. B01F 15/00; B01F 15/06

(52) U.S. Cl. 366/142; 366/144; 366/143

(57) ABSTRACT

The invention relates to a kitchen appliance (1) having a mixing vessel (2) and a stirrer located in the mixing vessel, wherein the mixing vessel can be heated and the kitchen appliance (1) has a time selector switch (5, 6) which enables a time selection in respect of the stirrer and/or the heating operation, wherein a pre-programmed sequence of preparation steps can furthermore be carried out. In order to carry out operation as safely as possible, according to the invention the sequence cannot be triggered until an active selection made by the user in respect of the time and/or stirrer and/or heating setting is made, insofar as a stir and/or heating operation is in the pre-programmed sequence, by means of the one or more selector switches. The invention further relates to a kitchen appliance (1) having a heatable mixing vessel (2) and a stirrer located in the mixing vessel (1), wherein the kitchen appliance allows for independent processing of preparation steps, wherein data can be transferred to the kitchen appliance (1) via a mobile device, in particular such as a mobile telephone. In order to increase safety in particular during automatic operation, another possible solution to the problem according to the invention is that the kitchen appliance (1) is connected to the mobile device by radio and an event such as a program end is reported to the mobile device, which triggers a signal of the mobile device.

The invention relates to a kitchen appliance having a mixing vessel and a stirrer located in the mixing vessel, the mixing vessel being heatable, and the kitchen appliance having time preselector switches, which enable a time preselection in respect of the stirrer and/or a heating operation, furthermore it being possible to carry out a sequence of preparation steps in a pre-programmed manner.

A kitchen appliance of this kind is known for example from DE 10 2007 059236 A1. Reference is also made for example to EP 757 530 B1, relating to a special preparation process, and to EP 1 274 333 B1, relating to a heating device in a kitchen appliance of this kind.

The invention is concerned with the problem of carrying out operation of a kitchen appliance of this kind as safely as possible.

One possible solution to this problem is provided, according to a first inventive concept, by the subject matter of claim 1, the solution being based in this case on the sequence being triggerable only when an active preselection, effected by the user, has taken place in respect of the setting of the time and/or the stirrer and/or the heating, in so far as a stirring operation and/or a heating operation is provided in the pre-programmed sequence, by means of one or more of the time preselector switches. Operation of the kitchen appliance in the automatic processing mode, thus an automatic operation of the kitchen appliance, is then only possible, when the time for the heating operation and/or operation of the stirrer has been set, by hand, in advance, on the selector switch provided for manual control on the kitchen appliance itself, in particular a rotary selector switch. This is in particular of importance when the process steps specified within an executable recipe can be freely changed by the user by input into a control device such as for example a computer or a mobile device, as further explained below. A deliberate, active intervention by the user is therefore required before the automatic operation of the kitchen appliance, it being also possible to ensure, in advantageous manner, with the aid of in particular the time preselector switch, that “endless operation” of the kitchen appliance does not take place. A hand preselector switch for the duration of the heating operation and/or operation of the stirrer of the kitchen appliance is for example cut off at a maximum time period of for example one, two or three hours. In the case of a digital and easily changeable control instruction, a multiple hour operation may however be set, which goes far beyond the time period specified, even if possibly only unintentionally. This can lead to safety problems during operation.

The invention also relates to a kitchen appliance having a mixing vessel and a stirrer located in the mixing vessel, the mixing vessel being heatable and it being possible to carry out an automatic execution of preparation steps, furthermore data being transmissible [to] the kitchen appliance via a mobile device such as in particular a mobile telephone/cellphone.

In order to improve safety, also in the case of such kitchen appliances, in particular during automatic operation, even if not in principle limited to this, the invention proposes in a further possible solution to the problem, according to the subject matter of claim 2, that the kitchen appliance is connected to the mobile device by radio and an event such as termination of a program is reported to the radio device, which report triggers a signal of the mobile device.

Such an event may in particular also be the exceeding of a prescribed temperature limit or for example a “boiling-over” detected by a suitable sensor on the kitchen appliance; further also, for example, a blocking of the stirrer, so that for example in a pre-programmed stirrer operation, a specified stirring speed is not reached or is not achieved with the requisite continuity.

Furthermore, it is provided that it is also possible to react to such a report by means of the mobile device, for example in that on the report of such an event, the machine is fully switched off, via the radio link, or a specified process step is terminated or repeated.

It is also provided that independently of a report of this kind, a switching-off or repetition of process steps can be transmitted to the kitchen appliance by means of the mobile radio device by way of remote control; for example, when because of specific events, the case arises that a preparation envisaged as first should be completed only later on.

The pre-programmed sequence of preparation steps preferably relates to recipes where all of the ingredients have already been put into the appliance (mixing vessel) and which recipes then still undergo a “process change”, if required. Thus for example a yeast dough must be stirred for a certain time after being kneaded, in order then to be kneaded once again, or a chocolate mousse must be warmed again and stirred well, after being cooled down. These procedures take place preferably without the user being present.

Further features of the invention are described below, also in the description of the figures, often in their preferred association with the claim concepts already explained above; they may however also be significant in association with one or more individual features which are described here, in particular the claims already dealt with, or independently, or in another overall concept. It is also possible to provide, in a combined manner, the features of the claims already dealt with.

In particular, it is preferred for it to be possible to carry out a bi-directional control of the kitchen appliance. This means that on the one hand, programs for execution, thus for example recipe steps, can be transmitted from a mobile device, such as in particular a mobile telephone, to the kitchen appliance, either stepwise or as “packets”, to be then executed automatically in the kitchen appliance. In order also, on the other hand, for signals and status information, as described, to be transmissible from the kitchen appliance to the mobile device, and for events, such as in particular the triggering of a signal or for example a camera function, or the like, to be controllable in dependence on prescribed threshold values, it is possible, for this purpose, for a camera, for example a so-called web camera, to be provided on the kitchen appliance, or separately from the kitchen appliance, or focused on the appliance. This camera can also be controlled from the mobile device, in that the camera is activated and pictures from the camera are transmitted to the mobile device.

Corresponding recipes can be stored in the kitchen appliance and/or in the mobile device as text and/or as image data and also as a video sequence. In this way, the images and the video sequence serve as a visualization for the user, which proceeds according as the recipe is executed in the kitchen appliance and/or for illustration of the result. In addition, the recipes contain appropriate data which can be transmitted as control data to the kitchen appliance and are transmitted for carrying out and executing a recipe. By storing the texts etc. in the kitchen appliance, they can be transmitted to the mobile device, for example released by an appropriate request from the mobile device, modified there and/or checked, and/or a choice encountered, and then suitably transmitted to the kitchen appliance in order to carry out or execute the recipe. Technically this may also manifest itself by a specific recipe, already stored in the kitchen appliance, being released for execution.

The recipes may be transmitted to the mobile device via an internet connection, a telephone connection, a cable connection (for example an Ethernet connection), or also in any other manner, such as for example by a USB stick, a memory card or the like, in particular also from sources external to the kitchen appliance. Furthermore, recipes may also be exchanged between mobile devices.

An acknowledgement from the kitchen appliance may also take place by in each case, a processing step which has been started, carried out or completed, being reported to the mobile device. This transmission can in each case trigger a signal at the mobile device. It may however also be merely stored there, and then called up at the option of the user.

The viscosity of a foodstuff being prepared in the mixing vessel may for example be detected by evaluating the torque of the motor (by way of the power consumption). If a prescribed limiting value for the viscosity is exceeded, for example during the processing of yeast dough or whipped cream, the rotational speed of the stirrer is preferably automatically reduced or the stirrer is stopped. A suitable message may be sent to the user on the mobile device, via the preferred bi-directional control, optionally with proposals as to how the user should act in this circumstance.

Furthermore it is also provided that one's own recipes can be programmed in the kitchen appliance and/or in the mobile device. For this, suitable software advantageously provides parameters, such as the selection of a specific stirring time in dependence on an ingredient provided, or a mixture provided, it being possible for these values to be then also changed or augmented by the user.

The recipes may be individually adapted by means of an edit feature. The edit feature is preferably provided in the mobile device.

Furthermore, it is also preferred for the software to provide parameters which specify with regard to the input of a specific calorie target or time target or dietary target, such as compliance with a specific diet, avoidance of allergies, a diet for specific special demands such as for example in sport etc.

A stepwise guide is also preferably provided by the thus to be understood creation program for a recipe.

Voice control, as is already present in many mobile devices such as mobile telephones, may also be applied to the processing and creation of a recipe.

Not least, the recipe program may also display a list of the ingredients to be supplied for a recipe, after the recipe has been created.

The invention is further explained below with reference to the accompanying drawing, which illustrates only one exemplary embodiment and in which:

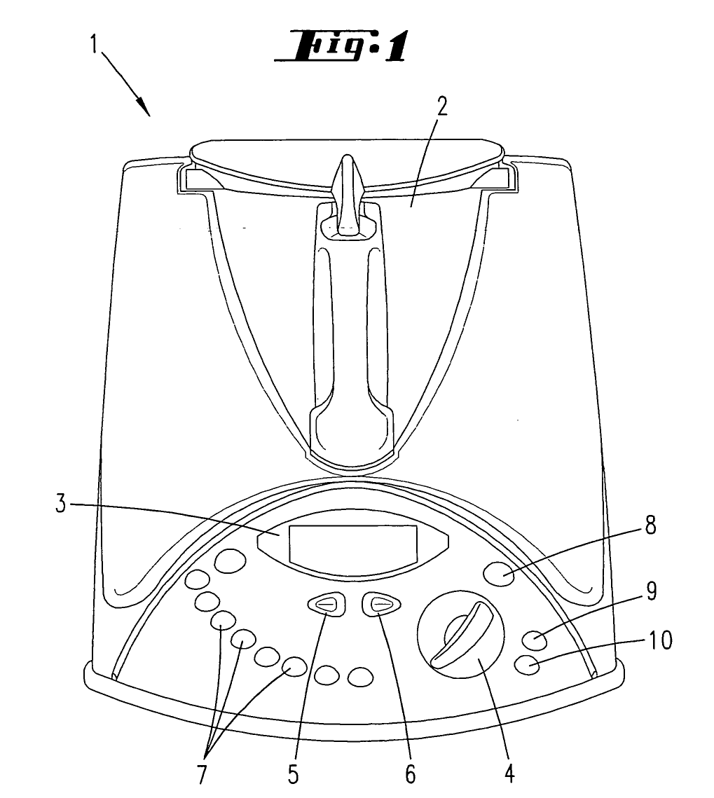

FIG. 1 shows a front view of a kitchen appliance with a heatable mixing vessel;

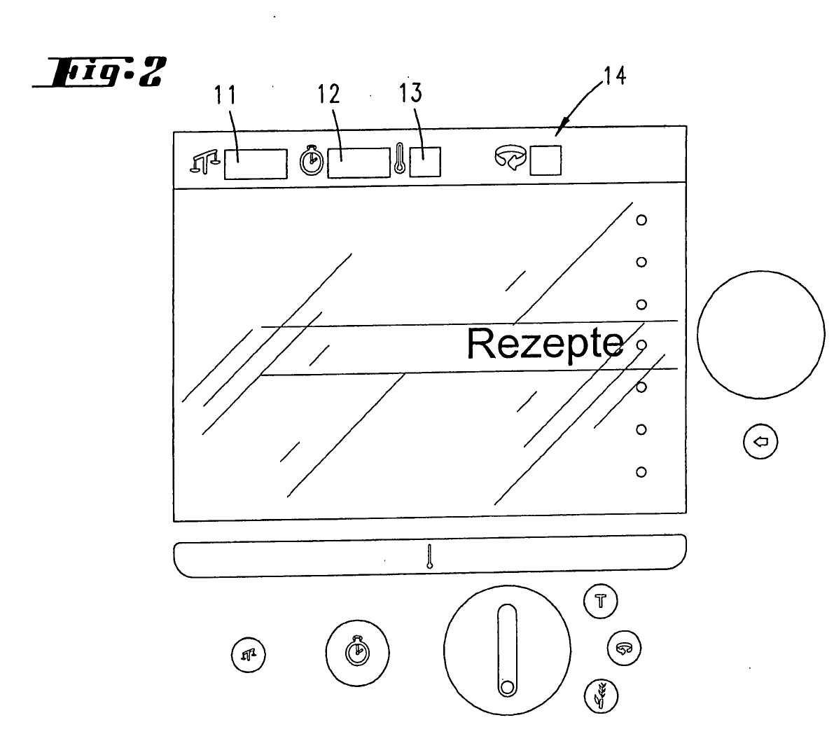

FIG. 2 shows an illustration of a display provided on the kitchen appliance;

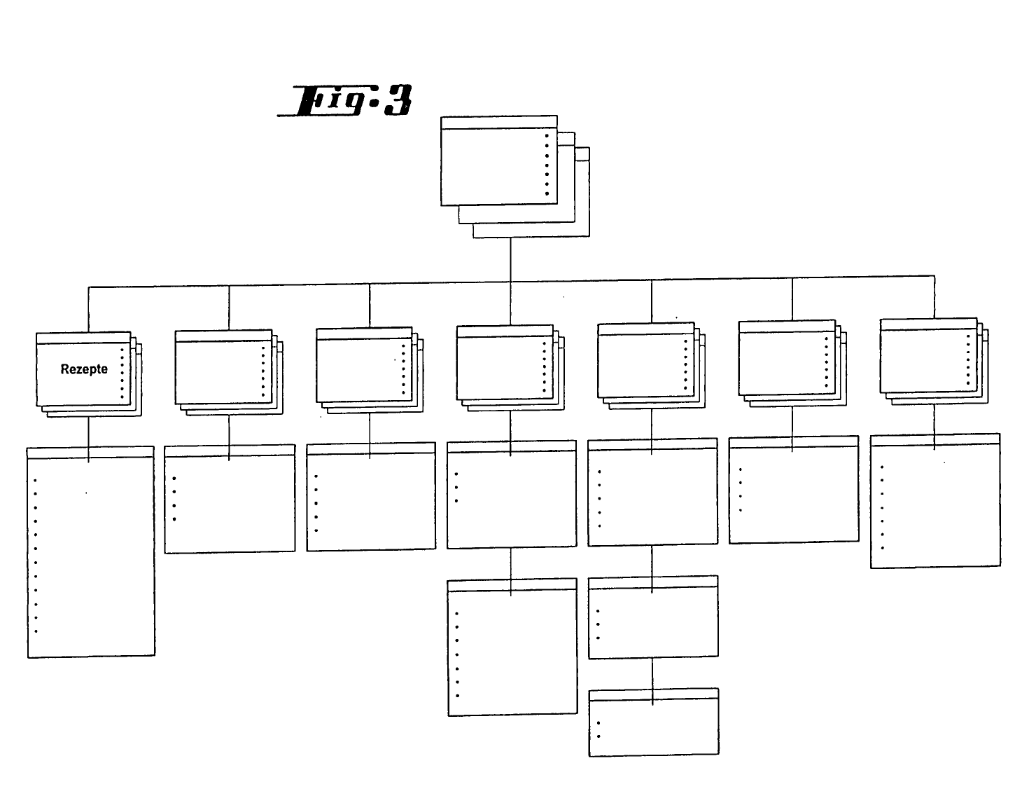

FIG. 3 shows a sequence schematic for program functions and contents provided.

A kitchen appliance 1 is shown and described, which is also known as “Vorwerk-Thermomix”. The kitchen appliance has a mixing vessel 2, with a blade unit/stirrer disposed on the base of the mixing vessel but not visible in the illustration. The mixing vessel is also heatable, for example by an electric resistance heater provided at the base of the mixing vessel (see for example EP 1 274 333 B1 mentioned at the beginning).

A display 3 is provided on the operator side of the appliance as is visible in FIG. 1. In addition, a rotary selector switch 4 for setting a stirrer speed is provided. Actuation buttons 5 and 6 are provided for a time adjustment by way of the display. Furthermore, buttons 7 are provided, laid out in the shape of an arc, which enable preselection of temperature. In addition, switches 8 to 10 are provided, and trigger specific functions, such as a turbo-feature, a weighing feature, or the like.

FIG. 2 shows an illustration of a possible display for the kitchen vessel itself and/or a mobile device, in which display, visible under “recipes”, recipes stored as favorites, special features, settings which do not require to be changed on each occasion etc., may be selected. In the upper region of the display, a weighed portion amount 11 and/or a time setting 12 and/or a temperature setting 13 can be shown. The display may be formed as a touchscreen-display. A symbol 14 can indicate that processing is going on.

FIG. 3 shows a possible selection from the chapters provided on the display, already previously mentioned with regard to FIG. 2. Data is assigned to these chapters, in each case in the form of databases.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optionally associated formulation characterize independent inventive development of the prior art, in particular to make divisional applications based on these claims.

1-4. (canceled)

5. Kitchen appliance (1) having a mixing vessel (2) and a stirrer located in the mixing vessel, the mixing vessel being heatable and the kitchen appliance (1) having a time preselector switch (5, 6), which enables a time preselection in respect of the stirrer and/or the heating operation, furthermore it being possible to carry out a sequence of preparation steps in a pre-programmed manner, for the automatic operation of the kitchen appliance, wherein the kitchen appliance is so arranged that the sequence can only be triggered when the time for the stirrer setting and/or the heating setting has been made, in advance and by hand, by the user, at the selector switch provided for hand operation on the kitchen appliance itself, in so far as a stirring operation and/or a heating operation is provided in the pre-programmed sequence, by means of one or more preselector switches.

6. Kitchen appliance (1) with a mobile device, the appliance having a mixing vessel (2) and a stirrer located in the mixing vessel (1), the mixing vessel being heatable, and the kitchen appliance allowing an automatic processing of preparation steps to be carried out, data being transmissible to the kitchen appliance (1) via a mobile device such as in particular a mobile telephone/cellphone, wherein the kitchen appliance (1) is arranged so that it is connected to the mobile device by radio, and is formed in such a way that one of the events:
termination of a program,
exceeding a prescribed temperature limit,
boiling-over detected by a sensor on the kitchen appliance,
blocking of the stirrer,
the start, carrying-out or completion of a processing step,
exceeding a prescribed limiting value of viscosity,
can be transmitted to the mobile device, and events such as the triggering of a signal or a camera function can be controlled there in dependence on prescribed threshold values.

7. Kitchen appliance according to claim 6, wherein when a prescribed limiting value for viscosity is exceeded, the speed of rotation of the stirrer is automatically reduced or the stirrer is stopped.

8. Method for operating a kitchen appliance (1) and a mobile device, the kitchen appliance (1) having a stirrer located in a mixing vessel (2), the mixing vessel being heatable, and the kitchen appliance allowing an automatic processing of preparation steps to be carried out, data being transmissible to the kitchen appliance (1) via a mobile device such as in particular a mobile telephone/cellphone, wherein the kitchen appliance (1) is linked to the mobile device by radio, and one of the events:
termination of a program,
exceeding a prescribed temperature limit,
boiling-over detected by a sensor on the kitchen appliance,
blocking of the stirrer,
the start, carrying-out or completion of a processing step,
exceeding a prescribed limiting value of viscosity,
is reported to the mobile device, and a signal is triggered in the mobile device in dependence on a prescribed threshold value, by such a report.

9. Kitchen appliance according to claim 5, wherein the kitchen appliance (1) can be remotely controlled by the mobile device.

10. Kitchen appliance according to claim 5, wherein a camera is provided on the kitchen appliance or separately from the kitchen appliance, but focused on this, and wherein this camera can be controlled by the mobile device in such a way that the camera is activated and pictures from the camera are transmitted to the mobile device.

11. Kitchen appliance according to claim 5, wherein the mobile device can be remotely controlled by the kitchen appliance (1).
